(19) United States
(12) Patent Application Publication
(10) Pub. No.: US 2019/0105142 A1
(43) Pub. Date: Apr. 11, 2019

(54) CUSTOMIZABLE TOOTHBRUSH TO IMPROVE THE ORAL HYGIENE AND METHOD TO PRODUCE THEREOF

(71) Applicants: Song Hoe Koo, Los Angeles, CA (US); Haewon Choi, Los Angeles, CA (US)

(72) Inventors: Song Hoe Koo, Los Angeles, CA (US); Haewon Choi, Los Angeles, CA (US)

(21) Appl. No.: 15/725,294

(22) Filed: Oct. 5, 2017

(51) Int. Cl. A61C 17/22; A61C 9/00; A61C 17/32; A46B 9/04; A46D 3/00

(52) U.S. Cl. CPC A61C 17/222; A61C 9/0053; A46D 3/00; A46B 9/045; A61C 17/228; A61C 17/32

(57) ABSTRACT

Disclosed is a customizable toothbrush produced in a real-time corresponding to a teeth structure of a user. The customizable toothbrush includes a silicone brush head, a sonic body, bristles, a conjoining unit, and occlusal stoppers. The silicone brush head is fabricated by negative shape/investing by utilizing an algorithm associated with additive manufacturing. The negative investing is obtained through scan model of the teeth structure captured by the direct intraoral scanner. The sonic body creates an oscillation motion while brushing the teeth. The bristles are arranged over the silicone brush head to clean the teeth structure. The conjoining unit joins the silicone brush head with the sonic body. The occlusal stoppers are placed into the silicone brush head to stabilize the silicone brush head in an oral cavity of the user. The occlusal stoppers allow the user to bite down on the silicone brush head at a desired position while brushing.

### TECHNICAL FIELD

The present invention generally relates to a customizable toothbrush and specifically relates to a customizable toothbrush produced in a real-time corresponding to a teeth structure of a user.

### BACKGROUND

Conventionally, many tooth brushes and pressurized pulsating water devices are used by the users for cleaning the teeth. Many individuals are more conscientious about maintaining good dental hygiene because of plaque, and food particles build up on teeth continuously. Further, there are various toothbrushes available which are mostly standardized and need user's dexterity and adaptation to correctly position in their oral cavity.

However, the aforementioned toothbrushes and teeth cleaning devices are not designed as per the specific teeth and failed to fit on the user's dentition and gingiva. Therefore there is a need for a method to produce a customizable toothbrush in real-time corresponding to individual's teeth shape and geometry to effectively clean the teeth in less time.

Further limitations and disadvantages of conventional and traditional approaches will become apparent to one of skill in the art through comparison of described systems with some aspects of the present disclosure, as set forth in the remainder of the present application and with reference to the drawings.

### SUMMARY OF THE INVENTION

A customizable toothbrush produced in a real-time corresponding to a teeth structure of a user is provided substantially, as shown in and/or described in connection with at least one of the figures, as set forth more completely in the claims.

According to the embodiments illustrated herein, a method to produce a customizable toothbrush in a real-time corresponding to a teeth structure of a user is provided. The present method improves the oral hygiene of the user. The method includes the step of obtaining a scan model of the teeth structure through a direct intraoral scanner or by utilizing a dental impression material directly from the user's mouth. Then the method includes the step of fabricating the negative shape/investing of a silicone brush head or a customized toothbrush tray by utilizing a pre-defined algorithm associated with additive manufacturing.

Further, the method includes the step of arranging the positions of a plurality of bristles over the fabricated silicone brush head at the most efficacious position to accommodate the user's need. In an embodiment, the customized silicone brush head is fabricated by utilizing the negative shape/investing. Furthermore, the method includes the step of creating an oscillation motion while brushing through a sonic body to cleanse the teeth. Then the method includes the step of joining the silicone brush head with the sonic body through a conjoining unit. The method then includes the step of stabilizing the silicone brush head in an oral cavity of the user through a plurality of occlusal stoppers placed into the silicone brush head. In an embodiment, the occlusal stoppers allow the user to bite down on the silicone brush head at a desired position while brushing.

According to the embodiments illustrated herein, a customizable toothbrush produced in a real-time corresponding to a teeth structure of a user is provided. The customizable toothbrush includes a silicone brush head, a sonic body, a plurality of bristles, a conjoining unit, and a plurality of occlusal stoppers. The silicone brush head is fabricated by a negative investing by utilizing an algorithm associated with additive manufacturing. The negative investing is obtained through a scan model of the teeth structure captured by a direct intraoral scanner. The sonic body creates an oscillation motion while brushing the teeth. The plurality of bristles is arranged over the silicone brush head to clean the teeth structure. The conjoining unit joins the silicone brush head with the sonic body. The plurality of occlusal stoppers is placed into the silicone brush head to stabilize the silicone brush head in an oral cavity of the user. The occlusal stoppers allow the user to bite down on the silicone brush head at a desired position while brushing.

These features and advantages of the present disclosure may be appreciated by reviewing the following description of the present disclosure, along with the accompanying figures wherein like reference numerals refer to like parts.

### BRIEF DESCRIPTION OF DRAWINGS

The accompanying drawings illustrate the embodiments of systems, methods, and other aspects of the disclosure. Any person with ordinary skills in the art will appreciate that the illustrated element boundaries (e.g., boxes, groups of boxes, or other shapes) in the figures represent an example of the boundaries. In some examples, one element may be designed as multiple elements, or multiple elements may be designed as one element. In some examples, an element shown as an internal component of one element may be implemented as an external component in another and vice versa. Furthermore, the elements may not be drawn to scale.

Various embodiments will hereinafter be described in accordance with the appended drawings, which are provided to illustrate, not limit, the scope, wherein similar designations denote similar elements, and in which:

FIG. 1 illustrates a flowchart of the method to improve the oral hygiene through a customizable toothbrush, in accordance with at least one embodiment;

FIG. 2 illustrates a general view of the silicone brush head, in accordance with at least one embodiment;

FIG. 3 illustrates a general view of the customizable toothbrush, in accordance with at least one embodiment; and

FIG. 4 illustrates an environmental diagram of the present invention, in accordance with at least one embodiment.

### DETAILED DESCRIPTION

The present disclosure is best understood with reference to the detailed figures and description set forth herein. Various embodiments have been discussed with reference to the figures. However, those skilled in the art will readily appreciate that the detailed descriptions provided herein with respect to the figures arc merely for explanatory purposes, as the methods and systems may extend beyond the described embodiments. For instance, the teachings presented and the needs of a particular application may yield multiple alternative and suitable approaches to implement the functionality of any detail described herein. Therefore, any approach may extend beyond certain implementation choices in the following embodiments.

References to “one embodiment”, “at least one embodiment”, “an embodiment”, “one example”, “an example”, “for example”, and so on indicate that the embodiment(s) or example(s) may include a particular feature, structure, characteristic, property, element, or limitation, but not every embodiment or example necessarily include that particular feature, structure, characteristic, property, element, or limitation. Furthermore, repeated use of the phrase “in an embodiment” does not necessarily refer to the same embodiment.

Unless defined otherwise, all technical and scientific terms used herein have the same meaning as commonly understood by one of the ordinary skills in the art to which this invention belongs. Although any method and material similar or equivalent to those described herein can also be used in the practice or testing of the present invention, the preferred methods and materials have been described. All publications, patents, and patent applications mentioned herein are incorporated in their entirety.

It is noted that as used herein and in the appended claims, the singular forms “a”, “and”, and “the” include plural referents unless the context clearly dictates otherwise. In the claims, the terms “first”, “second”, and so forth are to be interpreted merely as ordinal designations; they shall not be limited in themselves. Furthermore, the use of exclusive terminology such as “solely”, “only”, and the like in connection with the recitation of any claim element is contemplated. It is also contemplated that any element indicated to be optional herein may be specifically excluded from a given claim by way of a “negative” limitation. Finally, it is contemplated that any optional feature of the inventive variation(s) described herein may be set forth and claimed independently or in combination with any one or more of the features described herein.

All references cited herein, including publications, patent applications, and patents, are hereby incorporated by reference to the same extent as if each reference were individually and specifically indicated to be incorporated by reference, and were set forth in its entirety herein.

The recitation of ranges of values herein is merely intended to serve as a shorthand method of referring individually to each separate value falling within the range, unless otherwise indicated herein, and each separate value is incorporated into the specification as if it were individually recited herein.

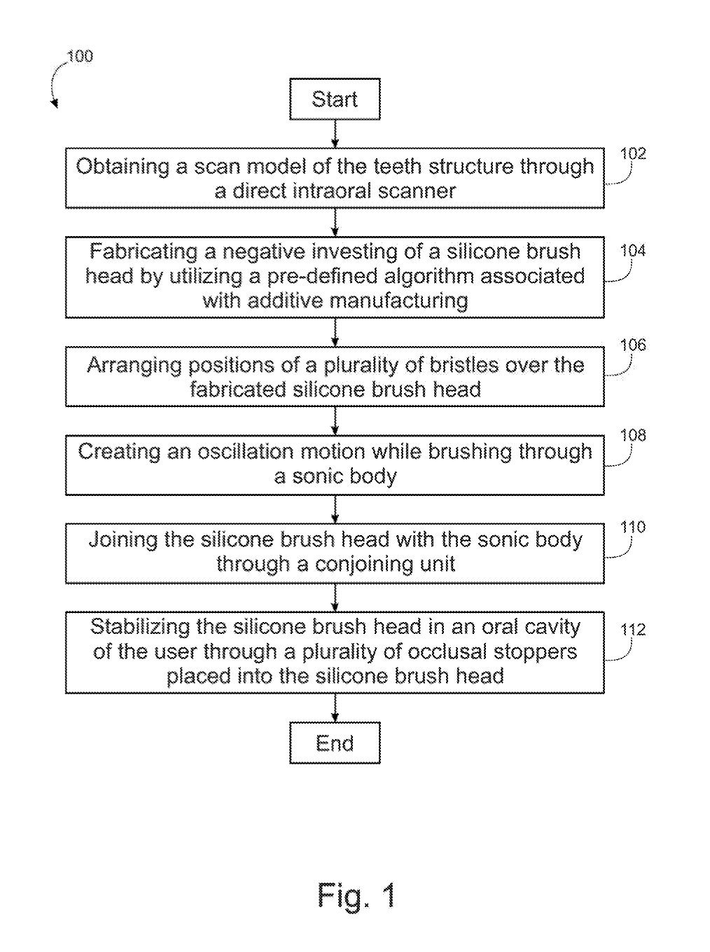

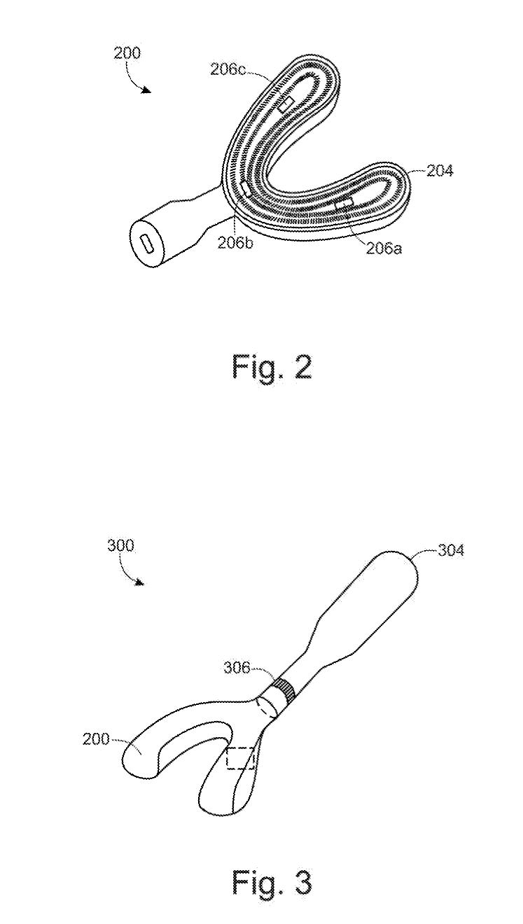

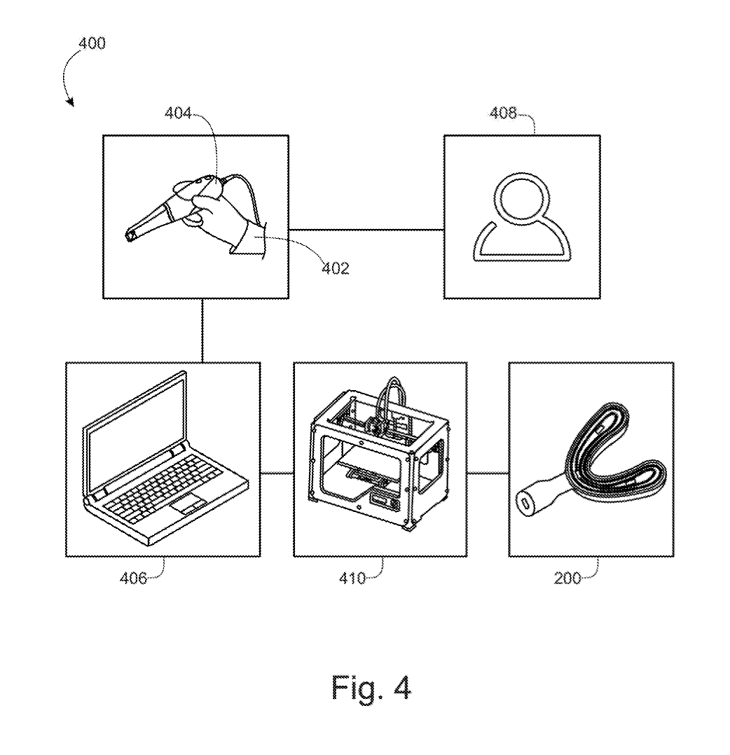

FIG. 1 illustrates a flowchart 100 of the method to produce a customizable toothbrush (shown and explained in conjunction with FIG. 3) in a real-time corresponding to a teeth structure of a user 408 (shown in FIG. 4), in accordance with at least one embodiment. The method initiates with the step 102 of obtaining a scan model of the teeth structure through a direct intraoral scanner 404 (shown in FIG. 4) or by utilizing a dental impression material directly from the user's mouth. Then the method includes the step 104 of fabricating the negative shape/investing of a silicone brush head 200 (shown in FIG. 2) or a customized toothbrush tray by utilizing a pre-defined algorithm associated with additive manufacturing such as 3D printing.

Further, the method includes the step 106 of arranging the positions of a plurality of bristles over the fabricated silicone brush head 200 at the most efficacious position to accommodate the user's need. In an embodiment, the customized silicone brush head 200 is fabricated by utilizing the negative shape/investing. Furthermore, the method includes the step 108 of creating an oscillation motion while brushing through a sonic body 304 (shown in FIG. 3) to cleanse the teeth. Then the method includes the step 110 of joining the silicone brush head 200 with the sonic body 304 through a conjoining unit 306. In an embodiment, the conjoining unit 306 is made of at least one of a metallic material, a plastic material.

The method then includes the step 112 of stabilizing the silicone brush head 200 in an oral cavity of the user through a plurality of occlusal stoppers 206a, 206b, and 206c (shown in FIG. 2) placed into the silicone brush head 200. In an embodiment, the occlusal stoppers 206a, 206b, and 206c allow the user 408 (shown in FIG. 4) to bite down on the silicone brush head 200 at a desired position while brushing. The plurality of occlusal stoppers 206a, 206b, and 206c provide an even pressure of a cleaning action to the teeth structure of the user 408.

The present method utilizes additive manufacturing or 3D printer 410 to optimize the effect of tooth brushing by customizing the shape of the silicone brush head 200 or a customized toothbrush tray to fit the dentition and gingiva of the user 408.

FIG. 2 illustrates a general view of the silicone brush head 200, in accordance with at least one embodiment. FIG. 2 is explained in conjunction with FIG. 1. The silicone brush head 200 resembles a dental plate or dentures covered in bristles. This silicone brush head 200 is a replica of the inside of user's 408 mouth. FIG. 3 illustrates a general view of the customizable toothbrush 300, in accordance with at least one embodiment. FIG. 2 is explained in conjunction with FIGS. 1-2.

The customizable toothbrush 300 includes a silicone brush head 200, a sonic body 304, a plurality of bristles 204, a conjoining unit 306, and a plurality of occlusal stoppers 206a, 206b, and 206c. The silicone brush head 200 is fabricated by a negative shape/investing by utilizing an algorithm associated with additive manufacturing such as 3D printing.

The negative shape/investing is obtained through a scan model of the teeth structure captured by a direct intraoral scanner (shown in FIG. 4). The sonic body 304 creates an oscillation motion while brushing the teeth. The plurality of bristles 204 is arranged over the silicone brush head 200 to clean the teeth structure. The conjoining unit 306 joins the silicone brush head 200 with the sonic body 304. The plurality of occlusal stoppers 206a, 206b, and 206c are placed into the silicone brush head 200 to stabilize the silicone brush head 200 in an oral cavity of the user 408. The occlusal stoppers 206a, 206b, and 206c allow the user to bite down on the silicone brush head at a desired position while brushing.

In an exemplary embodiment, three occlusal stoppers 206a, 206b, and 206c are placed into the silicone brush head 200 or the customized toothbrush tray to stabilize the customized toothbrush tray in the oral cavity of the user 408. The occlusal stoppers 206a, 206b, and 206e allow the user to bite down on the customized toothbrush tray at the same place every time to provide comfort to the user's 408 teeth.

FIG. 4 illustrates an environmental diagram 400 of the present invention, in accordance with at least one embodiment. In operation, a dentist 402 captures a 3D scan of the user/patient's 408 mouth through a direct intraoral scanner 404 and uploads the scanned file to a website configured with a computing device 406 where a computer aided design (CAD) is created. Alternatively, the dentist 402 can make a mold/cast of the patient's 408 teeth by utilizing a dental impression material. This is an inverse mold of the patient's 408 mouth.

Then the silicone brush head 200 is “printed” using the 3D printer 410. Stereo lithography technology is employed using ultraviolet curable photopolymer “resin” and an ultraviolet laser. The present silicone brush head 200 is constructed in successive layers using biocompatible materials and FDA approved plastics.

There are various advantages of the present customizable toothbrush 200 such as improving the oral hygiene of the user independent of user's teeth structure. Further, the present customizable toothbrush 200 enables the users 408 who have compromised dexterity, orthodontic appliance, various restorations and prosthesis including dental implants, fixed orthodontic appliances and have changed gum lines due to periodontal disease and crowding. Further, the present customizable toothbrush 300 uses 3D printing technology and improves the user's compliance, and enhances successful management of dental treatment and maintainability.

Furthermore, the present customizable toothbrush 300 simultaneously flosses and cleans the user's teeth, gums and tongue. Each bristle is tailored to the user's teeth, the bristles 204 are placed at a 45° angle along the gum line which is the angle recommended by dentists 402 for perfect brushing. Additional bristles 204 go in-between the user's 402 teeth. In an exemplary embodiment, at least 600 bristles are aligned to the user's specific teeth specifications. Additionally, the customizable toothbrush 200 may clean the user's 408 teeth in 6 seconds as the user 408 bite down and grind his/her teeth.

No language in the specification should be construed as indicating any non-claimed clement as essential to the practice of the invention.

It will be apparent to those skilled in the art that various modifications and variations can be made to the present invention without departing from the spirit and scope of the invention. There is no intention to limit the invention to the specific form or forms enclosed. On the contrary, the intention is to cover all modifications, alternative constructions, and equivalents falling within the spirit and scope of the invention, as defined in the appended claims. Thus, it is intended that the present invention cover the modifications and variations of this invention, provided they arc within the scope of the appended claims and their equivalents.

1. A method to produce a customizable toothbrush in a real-time corresponding to a teeth structure of a user, the method comprising steps of:
obtaining a scan model of the teeth structure through a direct intraoral scanner;
fabricating a negative investing of a silicone brush head by utilizing a pre-defined algorithm associated with additive manufacturing;
arranging positions of a plurality of bristles over the fabricated silicone brush head;
creating an oscillation motion while brushing through a sonic body;
joining the silicone brush head with the sonic body through a conjoining unit; and
stabilizing the silicone brush head in an oral cavity of the user through a plurality of occlusal stoppers placed into the silicone brush head, wherein the occlusal stoppers allow the user to bite down on the silicone brush head at a desired position while brushing.

2. The method according to claim 1, wherein the conjoining unit is made of at least one of a metallic material, a plastic material, and/or combination thereof.

3. The method according to claim 1, wherein the plurality of occlusal stoppers provide an even pressure of a cleaning action to the teeth structure of the user.

4. A customizable toothbrush produced in a real-time corresponding to a teeth structure of a user, the customizable toothbrush comprising:
a silicone brush head fabricated by a negative investing by utilizing an algorithm associated with additive manufacturing, wherein the negative investing is obtained through a scan model of the teeth structure captured by a direct intraoral scanner;
a sonic body to create an oscillation motion while brushing;
a plurality of bristles arranged over the silicone brush head to clean the teeth structure;
a conjoining unit to join the silicone brush head with the sonic body; and
a plurality of occlusal stoppers are placed into the silicone brush head to stabilize the silicone brush head in an oral cavity of the user, wherein the occlusal stoppers allow the user to bite down on the silicone brush head at a desired position while brushing.

5. The customizable toothbrush according to claim 4, wherein the conjoining unit is made of at least one of a metallic material, a plastic material, and/or combination thereof.

6. The customizable toothbrush according to claim 4, wherein the plurality of occlusal stoppers provides an even pressure of a cleaning action to the teeth structure of the user.
